(19) United States
(12) Patent Application Publication
(10) Pub. No.: US 2013/0317153 A1
(43) Pub. Date: Nov. 28, 2013

(54) DIISONONYL TEREPHTHALATE (DINT) AS SOFTENER FOR THERMOPLASTIC APPLICATIONS

(71) Applicants: Michael Grass, Haltern am See (DE); Hinnerk Gordon Becker, Essen (DE)

(72) Inventors: Michael Grass, Haltern am See (DE); Hinnerk Gordon Becker, Essen (DE)

(73) Assignee: Evonik Oxeno GmbH, Marl (DE)

(21) Appl. No.: 13/989,422

(22) PCT Filed: Oct. 31, 2011
(86) PCT No.: PCT/EP2011/069124

§ 371 Date: Aug. 6, 2013

(30) Foreign Application Priority Data
Nov. 24, 2010 (DE) 10 2010 061 868.3

(51) Int. Cl. C08K 5/12; C08K 3/26

(52) U.S. Cl. CPC C08K 5/12; C08K 3/26
USPC 524/296

(57) ABSTRACT

The present invention relates to the use of diisononyl terephthalate (DINT) as plasticizer for enhancing the low-temperature flexibilization and/or for enhancing the permanence in polymer compositions for thermoplastic applications.

The invention relates to the use of diisononyl terephthalate (DINT) as plasticizer for enhancing the low-temperature flexibilization and/or for enhancing the permanence in polymer compositions for thermoplastic applications.

Polyvinyl chloride (PVC) is one of the most important polymers in economic terms, and is used in various applications as plasticized PVC as well as unplasticized PVC. Examples of important application sectors are profiles, floor coverings, wall coverings and also manufactured leather. Plasticizers are added to PVC for enhanced elasticity. These customary plasticizers include, for example, phthalic esters such as di-2-ethylhexyl phthalate (DEHP), diisononyl phthalate (DINP) and diisodecyl phthalate (DIDP). Cyclohexanedicarboxylic esters have recently become known as further plasticizers, an example being diisononyl cyclohexanecarboxylate (DINCH). Certain terephthalates such as di-2-ethylhexyl terephthalate (DEHT) for example are also used as a further alternative.

A significant factor to be taken into account when deciding on the choice of plasticizer is the plasticizer's permanence in the particular end use, for example in the particular plastics moulding or article. The permanence of a plasticizer is determined particularly by its tendency to migrate and its volatility in/out of the particular polymer matrix. Very low volatility is generally desirable in order to minimize the fraction of plasticizer emitted from the plastics article by evaporation. The consequence of this for the material of construction is that its mechanical properties remain constant, particularly even when the material of construction is exposed to heightened thermal stress (i.e. a use temperature higher than room temperature).

Plasticizer volatility can be determined from the boiling point of the plasticizer itself, but also by determining the loss of mass after storage at elevated temperature of a PVC article produced with this plasticizer.

The application as insulating or sheathing material for electric cables utilizes formulations containing plasticized PVC. The formulations in question have to meet high safety requirements with regard to volatility, mechanical and electrical properties and also, for example, thermal stability. These requirements are mostly defined by national or international standards such as DIN EN 50363-4-1 (VDE 0207-363-4-1), DIN EN 50363-3 (VDE 0207-363-3) or, for example, by Underwriters Laboratories (UL) standards. These requirements also include the requirement that the cable coating and cable sheathing should exhibit good low-temperature flexibilization, i.e. shall remain bendable, and not become brittle, at low temperatures.

High permanence and good low-temperature flexibility are also very important in other application sectors of thermoplastic compounds, for example for PVC tubes and PVC membranes (e.g. roofing membranes), and also for PVC floor coverings.

The technical problem addressed by the present invention is therefore that of providing a chemical substance for use as plasticizer in compositions for thermoplastic applications that has high permanence in the particular end use and accordingly a low migration tendency and volatility, as well as fully meeting the mechanical and electrical demands in this application sector.

It is known from the literature (Beeler in Soc. Plast. Eng., Tech. Pap. (1976), 22, 613-615) that the performance characteristics of terephthalates resemble those of corresponding phthalates having side chains one carbon atom longer. For instance, di-2-ethylhexyl terephthalate (DEHT, C8 terephthalate) and DINP (C9 phthalate) behave relatively similarly.

WO 2009/095126 describes diisononyl esters of terephthalic acid which have a certain degree of branching. They are said to be useful as plasticizers, or part of a plasticizer composition, in plastics or plastics components, inter alia because these products have a low glass transition temperature and are liquid within a defined temperature interval. However, only a single example was used to show that a readily processable plastisol is obtainable therewith. Yet plastisols are only flowable mixtures of plasticizers and polymers (and optionally other additives); they are not “fully gelled” and therefore are not plasticized plastic. Therefore, nothing can be inferred about the suitability for particular applications.

In principle, the volatility of a plasticizer decreases within a homologous series with increasing molecular weight, i.e. its general usefulness increases with increased use temperatures. Applications involving different use temperatures may thus necessitate the selection of different plasticizers.

It is known from numerous publications that the volatility of diethylhexyl terephthalate (DEHT), as determined by the loss of mass of the PVC article (e.g. a PVC foil), is higher than that of corresponding articles containing diisononyl (ortho)phthalate (DINP) as plasticizer.

The expectation was therefore that a comparison of diisononyl terephthalate (DINT) with C10 (ortho)phthalates such as dipropylheptyl (ortho)phthalate (DPHP) or diisodecyl (ortho)phthalate (DIDP), which are the standard option for use in applications at elevated use temperature, would show the C9 terephthalate to have the higher volatility.

Yet the present inventors found that plastics articles, especially PVC articles such as, for example, PVC foils, PVC cable coatings, PVC cable sheathing, etc., that contain diisononyl terephthalate (DINT) as plasticizer, exhibit a lower loss of mass after storage at comparatively high temperature than the corresponding plastics articles which contain the same mass fraction of DIDP or DPHP as plasticizer.

This makes it possible to provide plastics articles that have excellent properties as materials (including a distinctly lower loss of mass at elevated use temperature) and at the same time are free of ortho-phthalates, while the diisononyl terephthalate is produced using an alcohol which is industrially available in high volumes. Esters of isononyl alcohol can accordingly be used in applications hitherto reserved to the costlier esters of C10 alcohols.

The use of diisononyl terephthalate (DINT) as plasticizer for thermoplastic applications has the additional advantage, over other plasticizers known from the prior art, that the plastics articles obtained, especially PVC articles such as, for example, cable coating and cable sheathing, have a particularly low glass transition temperature and thus exhibit good low-temperature flexibilization.

A further advantage is that the high permanence of terephthalic esters according to the present invention will reduce the plasticizer content of indoor air and house dust significantly even at elevated temperatures. This is very important for floor coverings and PVC membranes (e.g. roofing foils and roofing webs) in particular.

The present invention accordingly provides for the use of diisononyl terephthalate (DINT) as plasticizer for enhancing the low-temperature flexibilization and/or for enhancing the permanence in polymer compositions for thermoplastic applications.

Thermoplastic applications are any applications where the shaping step is carried out at the processing temperature (130 to 280° C., preferably 150 to 250° C.). Examples of thermoplastic methods of processing are calendering, extrusion, injection moulding, slush moulding, etc. In all cases, either a powder mixture or a pelletized material is brought into the desired shape by processing in the melt. Plasticization then occurs at the processing temperature whereby the molten primary particles become finely dispersed and a substantially homogeneous mass forms on cooling.

In a preferred embodiment, diisononyl terephthalate (DINT) is used as plasticizer in compositions for floor coverings, profiles, roofing foils or roofing webs, cable insulation and cable sheathing. DINT can further be used with advantage in compositions for tubes and receptacles, especially for storage and transportation of liquids such as water, blood, infusion solutions but also beverages. Examples of appropriate recipes for tubes and/or receptacles from the medical sector are recited in DE 202010004386 U1. Increased low-temperature flexibilization is also advantageous here, since numerous feed solutions or stored-blood units have to be stored at low temperature for a prolonged period without the receptacles becoming brittle. Furthermore, numerous applications such as, for example, tubes, swimming pool foils and profiles are used outdoors where they are exposed to high temperatures in the summer and low temperatures in the winter and therefore a high low-temperature flexibilization but also low volatility are advantageous.

Compositions for thermoplastic applications utilizing diisononyl terephthalate (DINT) according to the present invention as plasticizer contain at least one polymer and are particularly preferably in the form of a solid material (e.g. dry blend, powder, pellets) before the thermoplastic processing.

In a preferred embodiment, the polymer in the composition to be used according to the present invention is a polyvinyl chloride (PVC), polyvinylidene chloride (PVDC), polyvinyl butyrate (PVB) or a polyalkyl methacrylate (PAMA).

In a further preferred embodiment, the polymer can be a copolymer of vinyl chloride with one or more monomers selected from the group consisting of vinylidene chloride, vinyl acetate, vinyl propionate, vinyl butyrate, vinyl benzoate, methyl acrylate, ethyl acrylate or butyl acrylate.

The amount of diisononyl terephthalate in the composition is preferably in the range from 5 to 150 parts by mass, more preferably in the range from 10 to 100 parts by mass, even more preferably in the range from 15 to 90 parts by mass and most preferably in the range from 20 to 80 parts by mass per 100 parts by mass of polymer.

The composition may optionally contain further additional plasticizers other than diisononyl terephthalate, with which processing properties or the properties of the end product for example can be adjusted in a specific manner.

These plasticizers may be selected for example from the following list: dialkyl (ortho)phthalate, preferably having 4 to 13 carbon atoms in the alkyl chain; trialkyl trimellitates, preferably having 4 to 10 carbon atoms in the side chain; dialkyl adipates, preferably having 4 to 13 carbon atoms; dialkyl terephthalates each preferably having 4 to 8 carbon atoms and more particularly 4 to 7 carbon atoms in the side chain; alkyl 1,2-cyclohexanedicarboxylates, alkyl 1,3-cyclohexanedicarboxylates and alkyl 1,4-cyclohexanedicarboxylates, and preferably here alkyl 1,2-cyclohexanedicarboxylates each preferably having 4 to 13 carbon atoms in the side chain; dibenzoic esters of glycols; alkylsulfonic esters of phenol with preferably one alkyl radical containing 8 to 22 carbon atoms; polymeric plasticizers (based on polyester in particular), glyceryl esters, citric triesters having a free or carboxylated OH group and for example alkyl radicals of 4 to 9 carbon atoms, alkylpyrrolidone derivatives having alkyl radicals of 4 to 18 carbon atoms and also alkyl benzoates, preferably having 7 to 13 carbon atoms in the alkyl chain. In all instances, the alkyl radicals can be linear or branched and the same or different.

It is particularly preferable for the mixtures to be used according to the present invention not to use any ortho-phthalate as additional plasticizer.

It is further particularly preferable for the volatility of plasticizers and/or plasticizer mixtures used in addition to the terephthalic esters of the present invention to be at the same level (i.e. for example ±20% of the loss of mass detected with the terephthalic esters of the present invention) or lower than with the terephthalic esters of the present invention.

When an additional plasticizer is used, the mass ratio of additional plasticizers used and diisononyl terephthalate is preferably between 1:20 and 2:1.

It is further preferable for the composition to be used according to the present invention to contain one or more PVC types. It is very particularly preferable for the composition to be used according to the present invention to include one or more suspension PVCs whose molecular weight when specified as a K-value (Fikentscher constant) is between 60 and 90 and more preferably between 65 and 85.

The composition to be used according to the present invention may further contain additives to optimize the chemical, mechanical or processing properties, said additives being more particularly selected from the group consisting of fillers, pigments, thermal stabilizers, antioxidants, UV stabilizers, lubricating or slip agents, flame retardants, antistats, biocides, impact modifiers, blowing agents, (polymeric) processing aids, optical brighteners, etc.

Thermal stabilizers neutralize inter alia hydrochloric acid eliminated during and/or after processing of the PVC, and inhibit any thermal degradation of the polymer. Useful thermal stabilizers include all customary polymer stabilizers, especially PVC stabilizers in solid or liquid form, examples are those based on Ca/Zn, Ba/Zn, Pb, Sn or on organic compounds (OBS), and also acid-binding phyllosilicates such as hydrotalcite. The mixtures to be used according to the present invention may have a thermal stabilizer content of 0.5 to 10, preferably 0.8 to 5 and more preferably 1.0 to 4 parts by mass per 100 parts by mass of polymer.

It is likewise possible to use what are known as costabilizers with plasticizing effect, in particular epoxidized vegetable oils. It is very particularly preferable to use epoxidized linseed oil or epoxidized soya oil.

Antioxidants are generally substances which specifically suppress the free-radical polymer degradation caused by high-energy radiation for example by forming stable complexes with the resulting free radicals for example. It is more particularly the case that sterically hindered amines—known as HALS stabilizers, sterically hindered phenols, phosphites, UV absorbers, e.g. hydroxybenzophenones, hydroxyphenylbenzotriazoles and/or aromatic amines are included. Suitable antioxidants for use in the compositions of the present invention are also described for example in “Handbook of Vinyl Formulating” (editor: R. F. Grossman; J. Wiley & Sons; New Jersey (US) 2008). The level of antioxidants in the foamable mixtures of the present invention is more particularly not more than 10 parts by mass, preferably not more than 8 parts by mass, more preferably not more than 6 parts by mass and even more preferably between 0.01 and 5 parts by mass per 100 parts by mass of polymer.

Slip agents are intended to become effective between PVC particles and counteract frictional forces at mixing, plasticization and forming. They can also be used to adjust the sticking behaviour of the thermoplastic material to the (metallic for example) surfaces of the processing machines used.

Organic and inorganic pigments can be used. The level of pigments in the compositions to be used according to the present invention is not more than 10% by mass, preferably in the range from 0.01% to 5% by mass and more preferably in the range from 0.1% to 3% by mass per 100 parts by mass of polymer. Examples of inorganic pigments are TiO₂, CdS, CoO/Al₂O₃, Cr₂O₃. Known organic pigments are for example azo dyes, phthalocyanine pigments, dioxazine pigments and also aniline pigments.

As flame retardants there can be used for example antimony trioxide, phosphoric acids, chloroparaffins, bromine compounds, aluminium hydroxide, boron compounds, molybdenum trioxide or ferrocene. Preference is given to using antimony trioxide, aluminium hydroxide or phosphoric esters or other compounds that detach water for example. Flame retardants reduce flammability and can also, where applicable, reduce smoke evolution in the event of a fire. The compositions of the present invention may have a flame retardant content of up to 120 parts by mass per 100 parts of polymer and preferably from 0.01 to 25 parts by mass per 100 parts by mass of polymer.

The mixtures to be used according to the present invention may contain any fillers corresponding to the prior art. Examples of such fillers are mineral and/or synthetic and/or natural, organic and/or inorganic materials, for example calcium oxide, magnesium oxide, calcium carbonate, barium sulphate, silicon dioxide, phyllosilicate, carbon black, bitumen, wood (e.g. pulverized, as pellets, micropellets, fibres, etc.), paper, natural and/or synthetic fibres, etc. It is particularly preferable for at least one of the fillers used to be a calcium carbonate or a calcium magnesium carbonate.

The composition to be used according to the present invention can be produced in various ways. In general, however, the composition is produced by intensively mixing all components in a suitable mixing container at elevated temperatures. The PVC powder is here mixed mechanically, i.e. for example in fluid mixers, turbomixers, trough mixers or belt screw mixers with the plasticizer and the other components at temperatures to about 80° C. The components are added simultaneously or preferably in succession (see also E. J. Wickson “Handbook of PVC Formulating”, John Wiley and Sons, 1993, pp. 747 ff). Initially, the plasticizer penetrates adhesively into the voids of the PVC grain. As the mixing temperature progresses, the plasticizer is taken up into the voids of the primary particles making up the PVC grain, and becomes adsorptively bonded therein. The result of this process is a dry, generally flowable powder known as a PVC dry blend. The dry blend is subsequently sent to the appropriate thermoplastic moulding processes for producing the finished or semi-finished article, optionally a pelletizing step is interposed.

The composition to be used according to the present invention is particularly useful for production of products, semi-finished articles and/or mouldings containing at least a polymer selected from the group polyvinyl chloride or polyvinylidene chloride or polymethyl methacrylate or copolymers thereof. Examples of such products are floor coverings, roofing foils or roofing webs, building protection foils, and cable sheathing and wire insulation.

In general, a particularly good (i.e. low) glass transition temperature is achievable for the composition of the present invention by using a plasticizer which itself has a low glass transition temperature and/or by using a high plasticizer content. When PVC and plasticizer are mixed to form a dry blend, the glass transition temperatures of the components used can generally be measured, but not that of the final plasticized PVC after thermoplastic processing. Therefore, it is important to measure the glass transition temperature of the processed plastics article or intermediate to assess the degree of low-temperature flexibilization. The most suitable method of measurement is considered to be torsional oscillation analysis, since the results are highly reproducible and clearly defined glass transition points are identifiable. When the glass transition temperature of plasticized PVC is determined using calorimetric methods, for example differential scanning calorimetry (DSC), the glass transitions can often only be identified with difficulty, if at all, owing to very small amounts of heat being generated or absorbed. Test specimens produced by processing the compositions of the present invention have in particular glass transition temperatures in the range from −70° C. to +10° C., preferably in the range from −60° C. to −5° C., more preferably in the range from −50° C. to −20° C. and most preferably in the range from −45° C. to −30° C.

Furthermore, using DINT provides a distinctly reduced volatility and in some instances distinctly higher volume resistivities and thus improved insulation performance than obtained with the corresponding phthalates or the phthalates each lengthened by one carbon atom in the side chain.

The combination of low glass transition temperature on the one hand and low volatility on the other is more particularly important with applications where the end articles are exposed to both low temperatures and comparatively high temperatures.

Cables installed outdoors or in the ground must be mentioned here in particular, since they must not become brittle at winter temperatures, but must also survive the high temperatures of power transmission without significant loss of mass and hence performance sacrifices in the insulation.

But there are also other technical/industrial articles for use outdoors, for example tubes, profiles, geofoils, HGV tarpaulins, packaging foils, that can be advantageously additized with DINT.

The examples which follow illustrate the invention.

### EXAMPLES

Diisononyl terephthalate for use in the compositions of the present invention was produced as per WO 2009/095126 using isononanol from Evonik Oxeno GmbH.

Various plasticizers generally have different efficiencies, i.e. different amounts of plasticizers are needed to set a particular hardness, as measured via the Shore A hardness of DIN 53 505. For better comparability, preliminary tests were carried out to determine the plasticizer quantities needed to achieve approximately the same hardness. The plasticizer quantities in question are recited in Table 1.

### 1. Production of Test Specimens

First, dry blend mixtures were premixed in a Brabender Plasticorder. After heating the solid constituents to 88° C. the liquid constituents (composition see Table 1) were added followed by homogenization at 88° C. in the mixing container for 20 min. The mixture was subsequently plasticized on an oil-heated calender (from Collin, type “W 150 AP”) and processed into a milled sheet. The temperature of the two rolls was 165° C. in both cases. Milling time was 5 minutes. The cooled milled sheet was then compression moulded in a Collin laboratory press into 1 mm thick plates as follows: the temperature was adjusted to 170° C. and the sheet was initially compressed at 5 bar press pressure for one minute and then at 200 bar for two minutes. The compressed plate was subsequently cooled down to 40° C. at 200 bar in the course of 5 min.

To produce test specimens for determining the Shore hardness A, 2 mm thick plates were produced, placed on top of each other in threes and then measured in accordance with the particulars in Example 2.

### Recipe: (All Particulars in Parts by Mass)

TABLE 1

| Example | A | B | C | D | E |
|---|---|---|---|---|---|
| Solvin S 271 PC | 100 | 100 | 100 | 100 | 100 |
| (from Solvin) | | | | | |
| DINT (inventive) | 53 | | | | |
| VESTINOL 9 (DINP | | 50 | | | |
| from Evonik Oxeno, | | | | | |
| comparative example) | | | | | |
| JAYFLEX DIDP | | | 53 | | |
| (from Exxon Mobil, | | | | | |
| comparative example) | | | | | |
| Palatinol 10 P | | | | 53 | |
| (DPHP from BASF, | | | | | |
| comparative example) | | | | | |
| Eastman 168 (DEHT | | | | | 50 |
| from Eastman, | | | | | |
| comparative example) | | | | | |
| OMYA BSH | 80 | 80 | 80 | 80 | 80 |
| (calcium carbonate, | | | | | |
| from Omya) | | | | | |
| BP MC KA 83/5 | 4 | 4 | 4 | 4 | 4 |
| (stabilizer, from | | | | | |
| Baerlocher) | | | | | |

### 2. Determination of Shore Hardness A

The measurements themselves were carried out according to DIN 53 505, using a Shore A measuring appliance from Zwick-Roell, and in each case the measured value was read off after 3 seconds. Three different measurements were carried out on each test specimen on different places (not in the edge region), and the average value was recorded in each case.

TABLE 2

| | A (DINT, | | | | |
|---|---|---|---|---|---|
| Example | inventive) | B (DINP) | C (DIDP) | D (DPHP) | E (DEHT) |
| Shore | 92 | 90 | 91 | 92 | 92 |
| hardness A | | | | | |

All Shore hardnesses were at an interval of 91±1, i.e. within the experimental error of the method, and thus can be regarded as practically identical.

### 3. Measurement of Volatilities on Test Specimens

Circularly round test specimens were die-cut out of the 1 mm thick test plates, conditioned in a standard atmosphere (23° C., 50% relative humidity) for 24 h and then stored in a circulating air cabinet at 100° C. for 7 days, thereafter conditioned again as above and weighed back. The differences in mass were then related to the mass before starting the storage.

TABLE 3

| | A (DINT, | | | | |
|---|---|---|---|---|---|
| Example | inventive) | B (DINP) | C (DIDP) | D (DPHP) | E (DEHT) |
| Loss of | 0.17 | 0.86 | 0.49 | 0.74 | 1.74 |
| mass in % | | | | | |

### 4. Determination of Specific Volume Resistivity

The measurements hereinbelow were carried out to DIN IEC 60093 (VDE 0303 Part 30).

TABLE 4

| | A (DINT, | B | C | D | E |
|---|---|---|---|---|---|
| Example | inventive) | (DINP) | (DIDP) | (DPHP) | (DEHT) |
| Specific volume | 7.74 | 1.65 | 1.86 | 2.14 | 17.1 |
| resistance in | | | | | |
| 10¹³ ohm*cm at 23° C. | | | | | |
| Specific volume | 33 | 3.22 | 3.41 | 3.38 | 48.5 |
| resistance in | | | | | |
| 10¹¹ ohm*cm at 70° C. | | | | | |

DEHT shows good results on volume resistivity, but infirmities in volatility. By contrast, DINT gives better results than the standard plasticizers DPHP and DIDP on both volume resistivity and volatility.

### 5. Behaviour at Low Temperature

To determine low-temperature flexibility, the test specimens were measured using torsional oscillation analysis. The foils 1 mm in thickness were used to die-cut out pieces 60 mm in length, 80 mm in width and 1 mm in thickness, and these pieces were subjected in a torsional pendulum of the type MYRENNE ATM III to DIN EN ISO 6721 (Part 2) at temperatures of −100° C. to +100° C. and a frequency of 1 s⁻¹ to a determination of the storage modulus G′ and the loss modulus G″ in each case.

The glass transition temperature T_{G} was determined from the maximum of G″. T_{G} is a measure of flexibility at low temperatures.

The glass transition temperatures of the test specimens are listed in Table 5.

TABLE 5

| | A (DINT, | B | C | D | E |
|---|---|---|---|---|---|
| Recipe | inventive) | (DINP) | (DIDP) | (DPHP) | (DEHT) |
| Glass transition | −36 | −36 | −29 | −30 | −34 |
| temperature | | | | | |
| in ° C. | | | | | |

Low-temperature flexibilization using the DINT-containing mixture of the present invention is practically identical to that achieved using DINP. Compared with the C10 phthalates a distinct improvement is discernible, and an improvement is also achieved over DEHT.

Owing to the extremely low volatility, improved volume resistivity and the excellent low-temperature flexibilization, as evidenced by the glass transition point of the corresponding foil, the use of DINT for thermoplastic applications is a clear improvement over the prior art.

1. A method of enhancing low-temperature flexibilization, permanence, or both, in a polymer composition, the method comprising:
plasticizing the composition with diisononyl terephthalate (DINT) as a plasticizer,
wherein the composition is suitable for a thermoplastic application.

2. The method according to claim 1, wherein the composition is suitable for producing a floor covering, a roofing foil, a roofing web, or a cable sheathing.

3. The method of claim 1, wherein the composition comprises at least one polymer selected from the group consisting of polyvinyl chloride, polyvinylidene chloride, a copolymer of polyvinyl chloride and polyvinylidene chloride, and polyalkyl methacrylate (PAMA).

4. The method according to claim 3, wherein the at least one polymer is polyvinyl chloride.

5. The method according to claim 3, wherein the at least one polymer is a copolymer of vinyl chloride with at least one monomer selected from the group consisting of vinylidene chloride, vinyl acetate, vinyl propionate, vinyl butyrate, vinyl benzoate, methyl acrylate, ethyl acrylate, and butyl acrylate.

6. The method of claim 1, wherein an amount of diisononyl terephthalate (DINT) in the composition is from 5 to 90 parts by mass per 100 parts by mass of polymer.

7. The method of claim 1, wherein the composition further comprises a plasticizer other than diisononyl terephthalate.

8. The method of claim 1,
wherein the composition further comprises at least one additional plasticizer and
a mass ratio of further plasticizer to diisononyl terephthalate is between 1:20 and 2:1.

9. The method of claim 1, wherein the composition comprises suspension PVC.

10. The method of claim 1, wherein the composition comprises at least one additive selected from the group consisting of a filler, a pigment, a thermal stabilizer, an antioxidant, a viscosity regulator, and a lubricant.

11. A plastics product, comprising:
a polymer composition obtained by a process comprising the method according to claim 1,
wherein the polymer composition has a glass transition temperature, determined by torsional oscillation analysis or DMTA, of not more than −30° C.

12. A polymer composition, comprising:
a diisononyl terephthalate,
wherein the composition is less volatile than an otherwise identical composition comprising a C10 phthalate instead of a diisononyl terephthalate.

13. The plastics product of claim 11, wherein the glass transition temperature is from −45 to −30° C.
